(19) United States
(12) Patent Application Publication
(10) Pub. No.: US 2012/0196065 A1
(43) Pub. Date: Aug. 2, 2012

(54) DECORATION FILM AND DECORATED MOLDED DEVICE

(75) Inventors: Hsing-Yi Chen, Chiayi County (TW); Chen-Liang Wu, Tainan City (TW); Kai-Ching Hsu, Taoyuan County (TW)

(73) Assignee: ETANSI INC., Taoyuan County (TW)

(21) Appl. No.: 13/353,286

(22) Filed: Jan. 18, 2012

(30) Foreign Application Priority Data
Jan. 31, 2011 (TW) 100103730

(51) Int. Cl. B32B 1/02; B32B 5/16; B32B 7/06; B32B 27/08; B32B 7/12

(52) U.S. Cl. 428/36.4; 428/41.8; 428/40.2; 428/34.1; 428/35.7

(57) ABSTRACT

A decoration film including a carrier layer, a releasing layer disposed on the carrier layer, and a protection layer disposed on a side of the releasing layer away from the carrier layer is provided. In addition, a decorated molded device including a housing, an adhesion layer disposed on the housing, and a protection layer disposed on the adhesion layer and located at a side of the adhesion layer away from the housing is also provided. The protection layer has a compressible depth of at least 2 μm to 10 μm under a compression stress of 10 mN for providing soft touch feel.

### CROSS-REFERENCE TO RELATED APPLICATION

This application claims the priority benefit of Taiwan application serial no. 100103730, filed on Jan. 31, 2011. The entirety of the above-mentioned patent application is hereby incorporated by reference herein and made a part of this specification.

### BACKGROUND OF THE INVENTION

1. Field of the Invention

The invention relates to a decoration film and a decorated molded device and, particularly, to a decoration film which renders the decorated molded device the soft touch feeling effect.

2. Description of Related Art

With the tendency to small and thin volume of electronic products, the portable products such as the notebook, the personal digital assistant, the mobile phone, and the like are served as the applications in daily lives. In addition to the demands on the physical functions, the appearance of these products becomes an important factor when users purchase relevant products.

In the techniques for forming illustration or decoration on plastic housing of the electronic products, an in mold decoration (IMD) technique is provided, which includes an in mold roller (IMR), a heat transfer printing, a sublimation heat transfer, a hot stamping, an ink jet printing, a water transfer printing, etc. As to the IMR process, a pattern layer for decorating purpose and a protection layer for abrasion-resistant and scrape-resistant purposes are formed on a carrier layer to constitute a decoration film. Next, the decoration film is placed in a mold for an ejecting molding process. A thermal melted resin (or plastic material) is injected at a side of the decoration film by using an injecting molding process so that the thermal melted resin and the decoration film can be connected together. After the decoration film having the pattern layer and the protection layer is adhered on the plastic housing formed by the thermal melted resin, the carrier layer having releasing effect is tearing-off and the protection layer is exposed. As a result, the protection layer exposed as the outer-most layer can provide the protection function for preventing the plastic housing and the decorating pattern layer from improperly worm.

Now, with the variety of the use's habit, the plastic housing is required to provide different touch feeling effect in addition to the visual effect. For example, the user may want to feel soft touch feeling when touch the housing of the products. Accordingly, the hard protection layer may not satisfy the requirements of the users.

### SUMMARY OF THE INVENTION

The invention is directed to a decoration film capable of providing soft touch feeling effect.

The invention is directed to a decorated molded device having a protection layer capable of providing different touch feeling effect in the outer-most portion of the device.

The invention provides a decoration film including a carrier layer, a releasing layer disposed on the carrier layer, a protection layer disposed on the releasing layer, wherein the protection layer is a material with soft touching feeling effect, and an adhesion layer disposed on the protection layer.

According to an embodiment of the invention, the decoration film further includes a decoration layer disposed between the protection layer and the adhesion layer, wherein the decoration layer includes an ink layer or a metal layer.

According to an embodiment of the invention, the decoration film further includes a hard and brittle layer disposed between the protection layer and the adhesion layer.

According to an embodiment of the invention, a material of the protection layer includes a thermal curable material, a thermal plastic material, or a light curable material.

According to an embodiment of the invention, a material of the protection layer includes 2 KPU material. Specifically, the 2 KPU material is consisted of a plurality of aliphatic or aromatic polyol materials having a plurality of difunctional-groups or multifunctional-groups and one or more cross-linking agent having difunctional-group or multifunctional-group and containing —NCO group, wherein a molecular weight of the polyol materials ranges from 300 to 30,000.

According to an embodiment of the invention, a thickness of the protection layer is 6 μm to 80 μm.

According to an embodiment of the invention, a side of the protection layer adjacent to the releasing layer is a glare surface or a concave-convex surface. In specific, the decoration film further includes a resin layer and a plurality of protruding particles. The resin layer is disposed on the carrier layer, and the protruding particles are distributed in the resin layer and are protruded away the carrier layer from the resin layer. Furthermore, the releasing layer is disposed on the resin layer and the protruding particles and is curved with a ripple caused by the protruding particles and a side of the protection layer adjacent to the releasing layer is curved with the releasing layer to have the concave-convex surface. In one example, the decoration film further includes a resin layer treated by a surface concave-convex treatment completely or partially to have a plurality of concave-convex structures, wherein the resin layer is disposed on the carrier layer and the concave-convex structures are protruded away from the carrier layer. For example, the surface concave-convex treatment includes a printing process, a coating process, or an imprinting process. Furthermore, the releasing layer is disposed on the resin layer treated by the surface concave-convex treatment completely or partially and is curved with the concave-convex structures and a side of the protection layer adjacent to the releasing layer is curved with the releasing layer to have the concave-convex surface.

According to an embodiment of the invention, the adhesion layer is disposed at a side of protection layer away from the releasing layer. A thickness of the adhesion layer is substantially 3 μm to 20 μm.

According to an embodiment of the invention, the decoration film further includes an ink layer disposed at a side of protection layer away from the releasing layer.

According to an embodiment of the invention, the decoration film further includes a plurality of abrasion-resistant particles distributed in the protection layer. The abrasion-resistant particles includes polymer particles, metal particles, metal oxide particles, non-metal particles, extinction powders, or a combination thereof, and diameters of the abrasion-resistant particles are from 0.1 μm to 50 μm. In one embodiment, a material of the polymer particles comprises polyurethane, polymethyl methacrylate, or polytetrafluoroethylene. In addition, a material of the non-metal particles includes silicon dioxide or a silicate, and the silicate comprises quartz powder, mica powder, or clay.

The invention further provides a decorated molded device including: a housing, an adhesion layer disposed on the housing, and a protection layer disposed on the adhesion layer, wherein a compressible depth of the protection layer is 90% of a thickness of the protection layer under a pressure of 1000 mN and the compressible depth of the protection layer is at least 2 μm to 10 μm under a pressure of 10 mN.

According to an embodiment of the invention, an elastic recovery rate of the protection layer after being compressed is 60% to 95%.

According to an embodiment of the invention, the decoration film further includes a decoration layer disposed between the protection layer and the adhesion layer, wherein the decoration layer includes an ink layer or a metal layer.

According to an embodiment of the invention, the decoration film further includes a hard and brittle layer disposed between the protection layer and the adhesion layer.

According to an embodiment of the invention, a material of the protection layer includes a thermal curable material, a thermal plastic material, or a light curable material. The thermal curable material includes a 2 KPU material. Specifically, the 2 KPU material is consisted of a plurality of aliphatic or aromatic polyol materials having a plurality of difunctional-groups or multifunctional-groups and one or more cross-linking agent having difunctional-group or multifunctional-group and containing —NCO group, wherein a molecular weight of the polyol materials ranges from 300 to 30,000.

According to an embodiment of the invention, a thickness of the protection layer is 6 μm to 80 μm.

According to an embodiment of the invention, a side of the protection layer away from the adhesion layer is a glare surface or a concave-convex surface.

According to an embodiment of the invention, the adhesion layer is disposed at a side of protection layer adjacent to the housing and a thickness of the adhesion layer is 3 μm to 20 μm.

According to an embodiment of the invention, the protection layer further includes a plurality of abrasion-resistant particles. The abrasion-resistant particles includes polymer particles, metal particles, metal oxide particles, non-metal particles, extinction powders, or a combination thereof, and diameters of the abrasion-resistant particles are 0.1 μm to 50 μm. In one embodiment, a material of the polymer particles comprises polyurethane, polymethyl methacrylate, or polytetrafluoroethylene. A material of the non-metal particles includes silicon dioxide or a silicate, and the silicate comprises quartz powder, mica powder, or clay.

According to an embodiment of the invention, a texture pattern is formed on an ejection mold so that the decorated molded device has the texture pattern after being ejected from the ejection mold.

In view of the above, the thermal curable material such as 2 KPU material is selected to fabricate the protection layer in the invention, and the protection layer has a predetermined thickness, thereby the protection layer can have the soft touch feeling effect. Therefore, the decorated molded device fabricated by the decoration film according to the invention can provide the soft touch feeling to the user for achieving a variety of properties.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view of a decoration film according to one embodiment of the invention.

FIG. 2 is a schematic view of a decorated molded device fabricated by an IMD process using the decoration film depicted in FIG. 1 according to one embodiment of the invention.

FIG. 3 is a schematic view of a decoration film according to another embodiment of the invention.

FIG. 4 is a schematic view of a decorated molded device fabricated by an IMD process using the decoration film depicted in FIG. 3 according to one embodiment of the invention.

FIG. 5 is a schematic view of a decoration film according to further another embodiment of the invention.

FIG. 6 is a schematic view of a decorated molded device fabricated by an IMD process using the decoration film depicted in FIG. 5 according to one embodiment of the invention.

### DESCRIPTION OF EMBODIMENTS

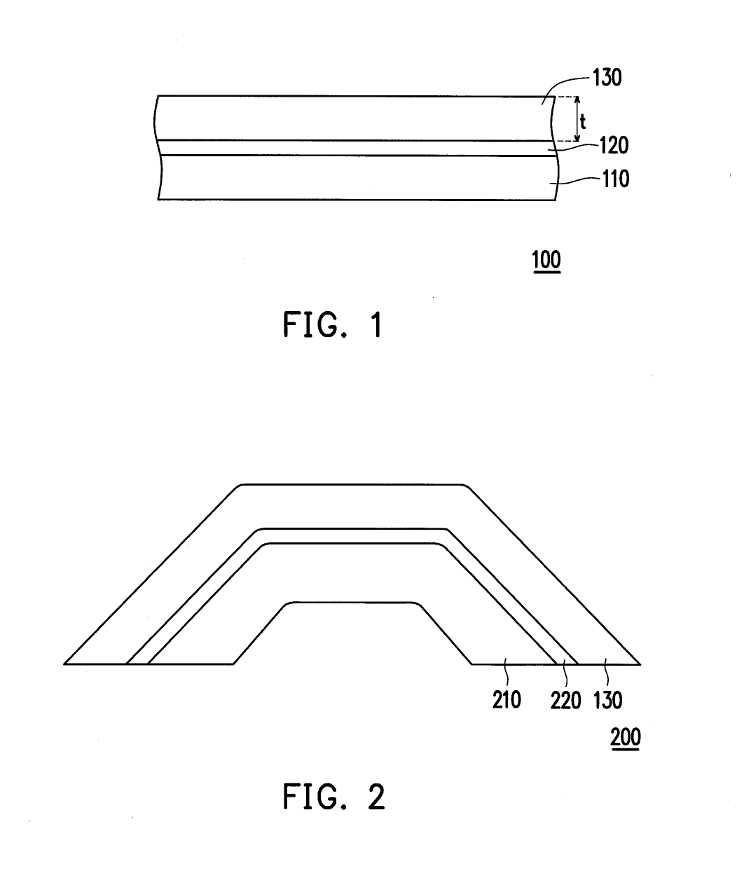

FIG. 1 is a schematic view of a decoration film according to one embodiment of the invention. As shown in FIG. 1, the decoration film 100 includes a carrier layer 110, a releasing layer 120, and a protection layer 130. The releasing layer 120 is disposed on the carrier layer 110 and the protection layer 130 is disposed at a side of the releasing layer 120 away from the carrier layer 110.

The carrier layer 110 can be polymer flexible film layer capable of providing the carrying function. A material of the carrier layer 110 can be polymers such as polyethylene terephthalate (PET), polyethylene naphthalate (PEN), polyethylene glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), triacetyl cellulose (TAC), polymethylmethacrylate (PMMA), MMA-St, MS, cyclo olefin copolymer (COC), or a combination thereof.

The releasing layer 120 is usually a thin film with low surface tension which can be made of a wax, a paraffin, or silicone, or an impermeable thin film with high smoothness which can be made of an irradiation curable multi-functional acrylic, silicone acrylate, epoxy, vinyl, alkyl vinyl compound, unsaturated polyester or a mixture thereof. A material of the releasing layer 120 can be selected from a polycondensate, a copolymer, a blend, or a mixture consisting of epoxy, polyurethane, polyimide, polyamide, hexa methoxymethyl melamine-formaldehyde, urea-formaldehyde, phenol-formaldehyde, and a combination thereof.

In addition, a side of the protection layer 130 adjacent to the releasing layer 120 is, for example, a glare surface. In the present embodiment, the protection layer 130 can provide the soft touch feeling and the protection function including abrasion-resistant effect and scrape-resistant effect. Therefore, the protection layer 130 has specific compressible depth and specific elastic recovery rate after being compressed.

For achieving the abovementioned characteristics, the protection layer 130 in the present embodiment can be fabricated by the thermal curable material, the thermal plastic material, or the light curable material, wherein the thermal curable material adopted in the present embodiment includes a 2 KPU material. A main portion of the 2 KPU material is consisted of a plurality of aliphatic or aromatic polyol materials having a plurality of difunctional-groups or multifunctional-groups and one or more cross-linking agent having difunctional-group or multifunctional-group and containing —NCO group, and a molecular weight of the polyol materials ranges from 300 to 30,000. Based on the foregoing descriptions, by selecting particular material, the protection layer 130 is a compressible layer and the elastic recovery rate of the protection layer 130 after being compressed is 60% to 95%. Accordingly, the decoration film 100 applied in the IMD process is conducive to fabricate a product with the soft touch feeling effect. That is to say, the protection layer 130 pressed by the user can be slightly caved in so that the user can have the soft touch feeling.

The protection layer 130 has the thickness greater than the conventional protection layer design and can provide the soft touch feeling, which may cause undesirable film separating effect during the IMD process. In other words, the film may not be easily cut completely along the predetermined cutting line to form independent decorated molded device. Therefore, in addition to select particular material for fabricating the protection layer 130, additional particles can be added therein for improving the film separating effect. Moreover, the adhesion of the releasing layer can be selectively increased (the releasing effect is reduced) or an additional hard and brittle layer can be additionally formed for achieving the required film separating effect.

In the present embodiment, the protection layer 130 can provide the soft tough feeling effect by using particular material, which may have unsatisfied abrasion-resistant effect so as to have negative influence on the appearance of the product. Abrasion-resistant material or particles can be selectively added in the protection layer 130 for enhancing the abrasion-resistant effect. The protection layer 130 has the thickness greater than the conventional design and can provide the soft touch feeling effect, which may cause undesirable ink broken effect during the IMD process. To prevent from the ink broken effect, a hard and brittle layer can be formed between the protection layer 130 and the releasing layer 120 during fabricating the decoration film 100.

FIG. 2 is a schematic view of a decorated molded device fabricated by an IMD process using the decoration film depicted in FIG. 1 according to one embodiment of the invention. As shown in FIG. 2, the decorated molded device 200 includes a housing 210, an adhesion layer 220, and a protection layer 130. In the present embodiment, an adhesion layer 220 can be further formed on the decoration film 100 depicted in FIG. 1 for applying in the IMD process to fabricate the decorated molded device 200. In the IMD process, the adhesion layer 220 is used for adhering the decoration film 100 to the polymer material in the mold. Next, after the polymer material is solidified (i.e. the housing is made), the releasing layer 120 and the carrier layer 110 can be tearing-off to form the decorated molded device 200 illustrated in FIG. 2. Generally, a texture pattern can be formed on an ejection mold during the fabrication of the decorated molded device 200, so that the decorated molded device 200 can have corresponding texture pattern after being ejected from the ejection mold. However, the embodiment is not limited thereto.

The protection layer 130 is fabricated by particular material to have the soft touch feeling function effect, so that the decorated molded device 200 can have the property for satisfying different requirements of the users. Furthermore, for enhancing the soft touch feeling effect provided by the protection layer 130, the thickness of the protection layer 130 can be 6 μm to 80 μm which is greater than the conventional protection layer. For having the needed visual effect, a decoration layer such as an ink layer or a metal layer can also be selectively formed between the protection layer 130 and the adhesion layer 220. That is to say, in other embodiments, the decoration film 100 depicted in FIG. 1 can further selectively be disposed with a decoration layer such as an ink layer or a metal layer between the protection layer 130 and the adhesion layer 220 rather than merely disposed with the adhesion layer 220 at a side of the protection layer 130 away from the releasing layer 120.

In the present embodiment, a material of the housing 210 includes polycarbonate (PC), acrylonitrile butadiene styrene (ABS), polyoxymethylene (POM), polybutylene terephthalate (PBT), polypropylene (PP), polymethylmethacrylate (PMMA), methylmethacrylate-styrene (MMA-st, MS), copolymer, MS, polystyrene (PS), polyethylene terephthalate (PET) or a combination thereof.

The adhesion layer 220 can be formed by the material selected from polyacrylate, polymethacrylate, polystyrene, polycarbonate, polyurethane, polyester, polyamide, epoxy resin, ethylene vinylacetate copolymer (EVA) or thermoplastic elastomer or a copolymer, blend, or combination thereof. In the present embodiment, the thickness of the adhesion layer 220 can be, for example, 3 μm to 20 μm which is greater than the conventional design so as to conduce to improve the abrasion-resistant effect of the protection layer 130.

In addition to the foregoing descriptions, an adhesion layer 220 can be previously formed on the decoration film 100 in the present embodiment before fabricating the decorated molded device 200 by using the IMD process, and subsequently the decoration film 100 formed with the adhesion layer 220 is placed into an oven for baking, wherein the time for baking the decoration film 100 according to the present embodiment can be longer than the baking time of the conventional decoration film. For instance, the baking process of the conventional decoration film formed with the adhesion layer is performed under the condition of the baking time of 24 hours and the baking temperature of 80° C. In the present embodiment, the baking process of the decoration film 100 formed with the adhesion layer 220 is performed under the condition of the increased baking time of 48 hours and the baking temperature of 80° C. By increasing the baking time of the adhesion layer 220, the abrasion-resistant effect and the scrape-resistant effect of the protection layer 130 can be enhanced.

In addition, the protection layer 130 in the present embodiment has the thickness greater than the conventional design, which may cause undesirable film separating effect during the IMD process. Now, the increasing of the baking time of the adhesion layer 220 can be conducive to prevent from the undesirable film separating effect of the decoration film 100. Therefore, the fabrication of the decorated molded device 200 can have desirable yield rate. In the present embodiment, the decorated molded device 200 can be, but is not restricted to, be a housing of a mobile phone, a housing of a digital camera, a housing of a personal digital assistant, a housing of a notebook, a housing of a desktop computer, a housing of a touch panel, a housing of a television, a housing of global positioning system, a housing of a display in automobiles, a housing of a display in navigation, a housing of a digital photo frame, a housing of a portable DVD player, a housing of a cosmetics, a housing of a toy, a car dashboard, a housing of a clock, a housing of a radio, a housing of a watch, a credit card, a smart card, etc.

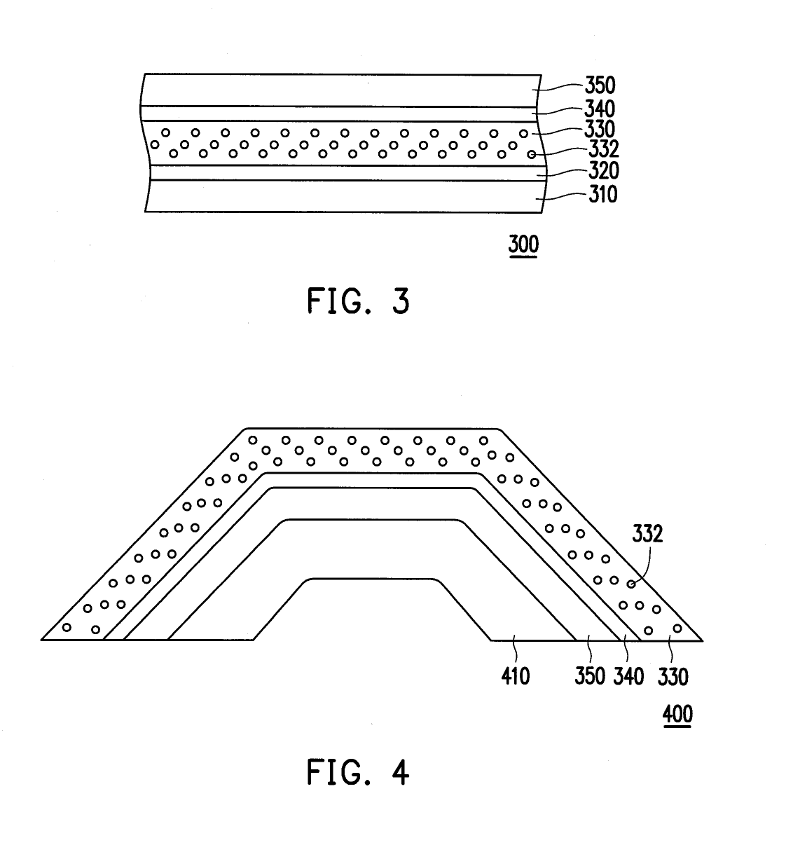

Furthermore, the invention is not limited to the above embodiments. FIG. 3 is a schematic view of a decoration film according to another embodiment of the invention while FIG. 4 is a schematic view of a decorated molded device fabricated by an IMD process using the decoration film depicted in FIG. 3 according to one embodiment of the invention. As shown in FIG. 3 and FIG. 4, the decoration film 300 includes a carrier layer 310, a releasing layer 320, a protection layer 330, an ink layer 340, and an adhesion layer 350. The releasing layer 320, the protection layer 330, the ink layer 340, and the adhesion layer 350 are sequentially disposed on the carrier layer 310. In addition, the decorated molded device 400 fabricated by the decoration film 300 includes a housing 410, the adhesion layer 350, the ink layer 340, and the protection layer 330, wherein the adhesion layer 350, the ink layer 340, and the protection layer 330 are sequentially disposed on the housing 410. Generally, a texture pattern can be formed on an ejection mold during the fabrication of the decorated molded device 400, so that the decorated molded device 400 can have corresponding texture pattern after ejecting from the ejection mold. However, the embodiment is not limited thereto.

In the present embodiment, the materials of the carrier layer 310, the releasing layer 320, the protection layer 330, the adhesion layer 350, and the housing 410 can be referred to the above descriptions in the foregoing embodiments and will not be reiterated herein. It is noted that the protection layer 330, in addition to be formed by the abovementioned material and have the thickness mentioned in above, is further configured with a plurality of abrasion-resistant particles 332 distributed therein. The configuration of the abrasion particles 332 is conducive to render the protection layer 330 with desirable scrape-resistant effect and abrasion-resistant effect without negatively influence on the soft touch feeling effect provided by the protection layer 330. That is to say, the abrasion-resistant particles 332 are used for enhancing the protection effect of the protection layer 330.

In the present embodiment, the abrasion particles 332 includes, for example, polymer particles, metal particles, metal oxide particles, non-metal particles, extinction powders, or any combination of the above, wherein the polymer includes polyurethane (PU), polymethylmethacrylate (PMMA), polytetrafluoroethylene, (TFE), or the like, and the non-metal material includes silicon dioxide, silicates such as quartz powders, mica powders, clay, and the like. Diameters of the abrasion particles 332 can be 0.1 μm to 50 μm. The ink layer 340 between the adhesion layer 350 and the protection layer 330 can be fabricated by a sublimation heat transfer ink, a heat-melted transfer ink, or a UV transfer ink. The ink layer 340 can be replaced by a metal layer in other embodiments. Alternately, a combination of the ink layer 340 and a metal layer (not shown) or a combination of the ink layer 340 and other decorating layer (not shown) can be selectively formed between the adhesion layer 350 and the protection layer 330. Furthermore, the ink layer 340 can be optionally completely formed on the surface of the housing 410 and can be patterned to be partially formed on the surface of the housing 410 to provide the required visual effect. That is to say, the decorated molded device 400 can have particular decoration pattern to have certain visual effect besides the soft touch feeling effect.

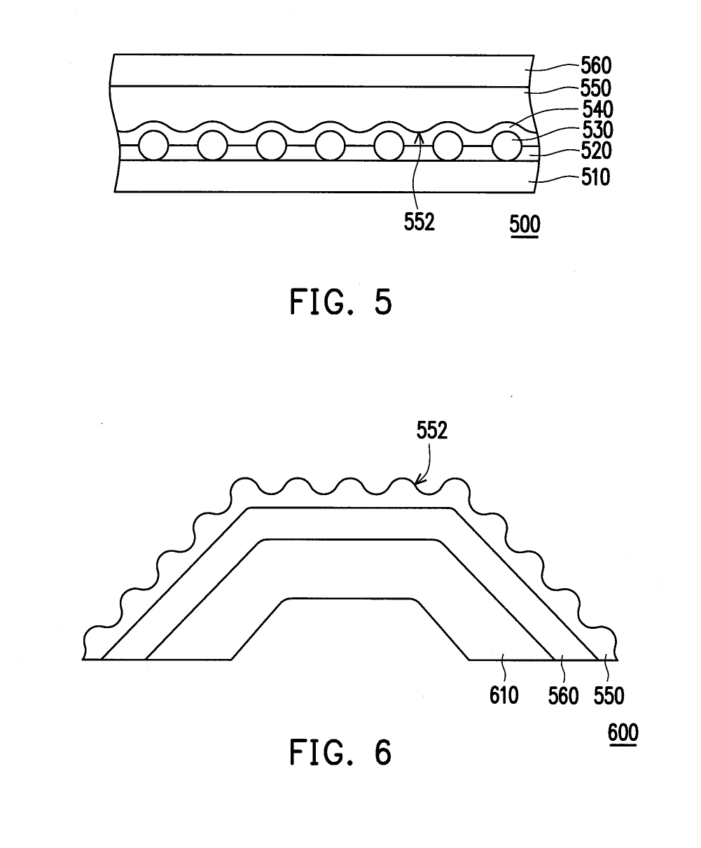

Furthermore, the above embodiments should by no means to limit the invention. FIG. 5 is a schematic view of a decoration film according to another embodiment of the invention while FIG. 6 is a schematic view of a decorated molded device fabricated by an IMD process using the decoration film depicted in FIG. 5 according to one embodiment of the invention. As shown in FIG. 5 and FIG. 6, the decoration film 500 includes a carrier layer 510, a resin layer 520, a plurality of protruding particles 530, a releasing layer 540, a protection layer 550, and an adhesion layer 560. The resin layer 520, the protruding particles 530, the releasing layer 540, the protection layer 550, and the adhesion layer 560 are sequentially disposed on the carrier layer 510. In addition, the decorated molded device 600 fabricated by the decoration film 500 includes a housing 610, the adhesion layer 560, and the protection layer 550, wherein the adhesion layer 560 and the protection layer 550 are sequentially disposed on the housing 610. Generally, a texture pattern can be formed on an ejection mold during the fabrication of the decorated molded device 600, so that the decorated molded device 600 can have corresponding texture pattern after ejecting from the ejection mold. However, the embodiment is not limited thereto.

In the present embodiment, the materials of the carrier layer 510, the releasing layer 540, the protection layer 550, the adhesion layer 560, and the housing 610 can be referred to the above descriptions in the foregoing embodiments and will not be reiterated herein. In the decoration film 500 according to the present embodiment, a side of the protection layer 550 adjacent to the releasing layer 540 has a concave-convex surface 552, which is conducive to enhance the soft touch feeling effect.

Specifically, the concave-convex surface 552 is formed by the configurations of the resin layer 520 and the protruding particles 530. The resin layer 520 is disposed on the carrier layer 510, and the protruding particles 530 are distributed in the resin layer 520 and are protruded away the carrier layer 510 from the resin layer 520. Accordingly, the releasing layer 540 disposed on the resin layer 520 and the protruding particles 530 can be curved with the ripple caused by the protruding particles 530. In addition, a side of the protection layer 550 adjacent to the releasing layer 540 can be curved with the releasing layer 540 to have the concave-convex surface 552. Specifically, the protection layer 550 can have the concave-convex surface 552 by the configurations of the resin layer 520 and the protruding particles 530 in the decoration film 500.

In another embodiment, the concave-convex surface 552 of the protection layer 550 can be formed by other methods. In one alternate example, the decoration film 500 selectively further includes a resin layer (not shown) treated by a surface concave-convex treatment completely or partially to have a plurality of concave-convex structures, wherein the resin layer (not shown) is disposed on the carrier layer 510 and the concave-convex structures are protruded away from the carrier layer 510. For example, the surface concave-convex treatment includes a printing process, a coating process, or an imprinting process. The releasing layer 540 is disposed on the resin layer (not shown) treated by the surface concave-convex treatment and is curved with the concave-convex structures. A side of the protection layer 550 adjacent to the releasing layer 540 is thus curved with the releasing layer 540 to have the concave-convex surface 552.

In the present embodiment, the material of the resin layer 520, for example, is polyurethane (PU), polymethyl methacrylate (PMMA), epoxide, polyester, or a combination thereof. A material of the protruding particles 530 can be silicone dioxide, calcium carbonate, calcium sulfate, barium sulfate, aluminum oxide, titanium oxide, or the like. The protruding particles 530 can alternately be metal powders, inorganic pigments, or organic pigments. Furthermore, the protruding particles 530 can be hollow balls, non-film-forming latexes or dispersions, etc. Diameters of the protruding particles 530 are from 0.1 μm to 30 μm, preferably 1 μm to 15 μm.

Owing to the concave-convex surface 552, the shineness of the protection layer 550 measured by the gloss meter is about 5° to 90° and the static friction coefficient of the protection layer 550 measured by the static friction meter is about 0.17 to 1.2. Therefore, in addition to provide the soft touch feeling effect, the protection layer 550 can present the mat visual effect.

What is more is, the touch feeling provided by the protection layer 550 can be more smooth when the distribution density of the protruding particles 530, i.e. the amount of the protruding particles 530 distributed in an unit area, is increased. On the contrary, the touch feeling provided by the protection layer 550 is relatively unsmooth. The touch feeling provided by the protection layer 550 can be more smooth when the diameters of the protruding particles 530 are decreased. On the contrary, the touch feeling provided by the protection layer 550 is relatively unsmooth.

Specifically, table 1 shows the property of the protection layer 550 measured by the dynamic hardness meter, wherein the compression measurement of the protection layer 550 includes forming the protection layer 550 having particular thickness on a PC/ABS housing to form a test sample and compressing and measuring the test sample under a pressure of 10 mN by using the super fine compression meter.

TABLE 1

| Test | Thickness (μm) of | Average compression | Average elastic |
|---|---|---|---|
| Samples | protection layer | thickness (μm) | recovery rate (%) |
| 1 | 15 | 4.51 | 80.41 |
| 2 | 15 | 4.89 | 76.57 |
| 3 | 13~16 | 3.60 | 72.55 |
| 4 | 15~18 | 2.42 | 73.38 |
| 5 | 10 | 4.34 | 64.05 |
| 6 | 15 | 4.49 | 76.30 |
| 7 | 15 | 4.44 | 68.61 |
| 8 | 20 | 2.63 | 69.76 |
| 9 | 30 | 3.79 | 84.28 |
| 10 | 40 | 4.76 | 88.96 |
| 11 | 60 | 5.57 | 92.08 |
| 12 | 40 | 8.88 | 93.69 |
| 13 | 60 | 10.86 | 93.07 |

Based on table 1, the protection layer 550 according to the present embodiment has a compressible depth of at least 2 μm to 10 μm under the pressure of 10 mN. In addition, the elastic recovery rate of the protection layer 550 after being compressed is 60% to 95%.

It is noted that the soft touch feeling effect provided by the protection layer 550 can be modulated by changing the ripple scale of the concave-convex surface 552 in addition to fabricating the protection layer 550 by selecting particular material (such as 2 KPU material) and setting particular thickness (6 μm to 80 μm). The embodiments of the invention can be used for accomplishing the requirement of the users for having a product with the housing capable of providing particular touch feeling effect. It is noted that the embodiments in the aforesaid descriptions are not intents to limit the scope of the invention. The invention can be achieved by making the protection layer of a decorated molded device have desirable elastic recovery rate and compressible depth through other designs or methods.

In light of the foregoing, the decoration film of the invention has the protection layer with compressible and elastic recovery properties and the decoration film is used for fabricating a decorated molded device. The user can have soft touch feeling when touches the decorated molded device. Meanwhile, the protection layer can provide desirable abrasion-resistant effect and scrape-resistant effect. Additionally, the protection layer according to the invention can provide particular touch feeling effect based on variant requirements. Namely, in addition to provide the protection effect, the protection layer of the invention can provide various touch feeling effect to satisfy the demands of the users.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A decoration film comprising:
a carrier layer;
a releasing layer disposed on the carrier layer;
a protection layer disposed on the releasing layer, wherein the protection layer is a material with a soft touch feeling effect; and
an adhesion layer disposed on the protection layer.

2. The decoration film as claimed in claim 1, further comprising a decoration layer disposed between the protection layer and the adhesion layer, wherein the decoration layer comprises an ink layer or a metal layer.

3. The decoration film as claimed in claim 1, further comprising a hard and brittle layer disposed between the protection layer and the adhesion layer.

4. The decoration film as claimed in claim 1, wherein a material of the protection layer comprises thermal curable material, a thermal plastic material, or a light curable material.

5. The decoration film as claimed in claim 4, wherein the thermal curable material comprises a 2 KPU material, a main portion of the 2 KPU material is consisted of a plurality of aliphatic or aromatic polyol materials having a plurality of difunctional-groups or multifunctional-groups and one or more cross-linking agent having difunctional-group or multifunctional-group and containing —NCO group, and a molecular weight of the polyol materials ranges from 300 to 30,000.

6. The decoration film as claimed in claim 1, wherein a thickness of the protection layer is 6 μm to 80 μm.

7. The decoration film as claimed in claim 1, wherein a side of the protection layer adjacent to the releasing layer is a glare surface or a concave-convex surface.

8. The decoration film as claimed in claim 7, further comprising a resin layer and a plurality of protruding particles, the resin layer being disposed on the carrier layer, the protruding particles being distributed in the resin layer, and the protruding particles being protruded away the carrier layer from the resin layer.

9. The decoration film as claimed in claim 8, wherein the releasing layer is disposed on the resin layer and the protruding particles and is curved with a ripple caused by the protruding particles and a side of the protection layer adjacent to the releasing layer is curved with the releasing layer to have the concave-convex surface.

10. The decoration film as claimed in claim 7, further comprising a resin layer treated by a surface concave-convex treatment completely or partially to have a plurality of concave-convex structures, wherein the resin layer is disposed on the carrier layer and the concave-convex structures are protruded away from the carrier layer.

11. The decoration film as claimed in claim 10, wherein the surface concave-convex treatment comprises a printing process, a coating process, or an imprinting process.

12. The decoration film as claimed in claim 11, wherein the releasing layer is disposed on the resin layer treated by the surface concave-convex treatment completely or partially and is curved with the concave-convex structures, and a side of the protection layer adjacent to the releasing layer is curved with the releasing layer to have the concave-convex surface.

13. The decoration film as claimed in claim 1, wherein the adhesion layer is disposed on a side of the protection layer away from the releasing layer and a thickness of the adhesion layer is 3 μm to 20 μm.

14. The decoration film as claimed in claim 1, wherein the protection layer further comprising a plurality of abrasion-resistant particles, the abrasion-resistant particles comprises polymer particles, metal particles, metal oxide particles, non-metal particles, extinction powders, or a combination thereof, and diameters of the abrasion-resistant particles are from 0.1 μm to 50 μm.

15. The decoration film according to claim 14, wherein a material of the polymer particles comprises polyurethane, polymethyl methacrylate, or polytetrafluoroethylene.

16. The decoration film as claimed in claim 14, wherein a material of the non-metal particles comprises silicon dioxide or a silicate, and the silicate comprises quartz powder, mica powder, or clay.

17. A decorated molded device, comprising:
a housing,
an adhesion layer disposed on the housing, and
a protection layer disposed on the adhesion layer, wherein a compressible depth of the protection layer is 90% of a thickness of the protection layer under a pressure of 1000 mN and the compressible depth of the protection layer is at least 2 μm to 10 μm under a pressure of 10 mN.

18. The decorated molded device as claimed in claim 17, wherein an elastic recovery rate of the protection layer after being compressed is 60% to 95%.

19. The decorated molded device as claimed in claim 17, wherein the decoration film further comprises a decoration layer disposed between the protection layer and the adhesion layer, wherein the decoration layer comprises an ink layer or a metal layer.

20. The decorated molded device as claimed in claim 17, wherein the decoration film further comprises a hard and brittle layer disposed between the protection layer and the adhesion layer.

21. The decorated molded device as claimed in claim 17, wherein a material of the protection layer comprises thermal curable material, a thermal plastic material, or a light curable material.

22. The decorated molded device as claimed in claim 21, wherein the thermal curable material comprises a 2 KPU material, a main portion of the 2 KPU material is consisted of a plurality of aliphatic or aromatic polyol materials having a plurality of difunctional-groups or multifunctional-groups and one or more cross-linking agent having difunctional-group or multifunctional-group and containing —NCO group, and a molecular weight of the polyol materials ranges from 300 to 30,000.

23. The decorated molded device as claimed in claim 22, wherein a thickness of the protection layer is 6 μm to 80 μm.

24. The decorated molded device as claimed in claim 17, wherein a side of the protection layer away from the adhesion layer is a glare surface or a concave-convex surface.

25. The decorated molded device as claimed in claim 17, wherein the adhesion layer is disposed on a side of the protection layer adjacent to the housing and a thickness of the adhesion layer is 3 μm to 20 μm.

26. The decorated molded device as claimed in claim 17, wherein the protection layer further comprising a plurality of abrasion-resistant particles, the abrasion-resistant particles comprises polymer particles, metal particles, metal oxide particles, non-metal particles, extinction powders, or a combination thereof, and diameters of the abrasion-resistant particles are 0.1 μm to 50 μm.

27. The decorated molded device as claimed in claim 17, wherein a material of the polymer particles comprises polyurethane, polymethyl methacrylate, or polytetrafluoroethylene.

28. The decorated molded device as claimed in claim 17, wherein a material of the non-metal particles comprises silicon dioxide or a silicate, and the silicate comprises quartz powder, mica powder, or clay.

29. The decorated molded device as claimed in claim 17, wherein a texture pattern is formed on an ejection mold so that the decorated molded device has the texture pattern after being ejected from the ejection mold.
